(19) United States
(12) Patent Application Publication
(10) Pub. No.: US 2019/0025128 A1
(43) Pub. Date: Jan. 24, 2019

(54) NON-CONTACT INFRARED MEASUREMENT OF SURFACE TEMPERATURE

(71) Applicant: Brown University, Providence, RI (US)

(72) Inventors: Rodney Clifton, Barrington, RI (US); Tong Jiao, Cumberland, RI (US); Pinkesh Malhotra, Providence, RI (US)

(21) Appl. No.: 16/031,694

(22) Filed: Jul. 10, 2018

Related U.S. Application Data
(60) Provisional application No. 62/530,596, filed on Jul. 10, 2017.

(51) Int. Cl. G01J 5/08

(52) U.S. Cl. CPC G01J 5/0887; G01J 2005/0081; G01J 5/0875

(57) ABSTRACT

A method and apparatus for non-contact infrared measurement of surface temperature. A method includes providing an infrared temperature measurement system, and increasing an emissivity of an interface between a metal and an infrared transparent window across which shear stresses are transmitted.

### CROSS REFERENCE TO RELATED APPLICATIONS

This application claims benefit from U.S. Provisional Patent Application Ser. No. 62/530,596, filed Jul. 10, 2017, which is incorporated by reference in its entirety.

### STATEMENT REGARDING GOVERNMENT INTEREST

This invention was made with government support under grant number GR5210000 awarded by the United States Air Force (Eglin Air Force Base). The Government has certain rights in the invention.

### BACKGROUND OF THE INVENTION

The present invention relates generally to the measurement of surface temperature, and more particularly to non-contact infrared measurement of surface temperature.

The intensity of the infrared radiation emitted by objects is mainly a function of their temperature. In infrared thermography, this feature is used for multiple purposes: as a health indicator in medical applications, as a sign of malfunction in mechanical and electrical maintenance or as an indicator of heat loss in buildings.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a method including providing an infrared temperature measurement system, and increasing an emissivity of an interface between a metal and an infrared transparent window across which shear stresses are transmitted.

In another aspect, the invention features a method including providing an infrared temperature measurement system, the infrared temperature measurement system having at least a source of infrared radiation and an IR detector for calculating an emitted power from the interface when exposed to the source of infrared radiation, and increasing an emissivity of an interface between a metal and an infrared transparent window across which shear stresses are transmitted.

In still another aspect, the invention features a method including providing an infrared temperature measurement system, the infrared temperature measurement system having at least a source of infrared radiation and an IR detector for calculating an emitted power from the interface when exposed to the source of infrared radiation, and increasing an emissivity of an interface between a metal and an infrared transparent window across which shear stresses are transmitted, wherein increasing the emissivity includes using lapped metal surfaces backed by ZnSe windows.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an exemplary infrared temperature measurement system.

FIG. 2 is an exemplary emission from a blackbody.

FIG. 3 is an exemplary layout of a collimating 90 degree OAP.

FIG. 4 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Infrared thermography (IRT) is a science dedicated to the acquisition and processing of thermal information from non-contact measurement devices. It is based on infrared radiation (below red), a form of electromagnetic radiation with longer wavelengths than those of visible light. Any object at a temperature above absolute zero (i.e., T>0 K) emits infrared radiation. A human eye cannot see this type of radiation. Thus, infrared measuring devices are required to acquire and process this information.

In general, infrared measuring devices acquire infrared radiation emitted by an object and transform it into an electronic signal. Most advanced devices include an array of sensors to produce a detailed infrared image of a scene. One difference between a visible image and an infrared image is that the visible image is a representation of the reflected light on the scene, whereas in the infrared image, the scene is the source and can be observed by an infrared camera without light. Images acquired using infrared cameras are converted into visible images by assigning a color to each infrared energy level. The result is a false-color image called a thermogram.

In summary, infrared radiation is the energy radiated by the surface of an object whose temperature is above absolute zero. The emitted radiation is a function of the temperature of the material; the higher the temperature, the greater the intensity of the infrared energy emitted.

There are three ways by which the radiant energy striking an object may be dissipated: absorption, transmission and reflection. The fractions of the total radiant energy that are associated with each of these modes of dissipation are referred to as the absorptivity, transmissivity and reflectivity of the body. Three parameters are used to describe these phenomena: the spectral absorptance α_{λ}, which is the ratio of the spectral radiant power absorbed by the object, the spectral reflectance ρ_{λ}, which is the ratio of the spectral radiant power reflected by the object, and the spectral transmittance τ_{λ}, which is the ratio of the spectral radiant power transmitted by the object. These three parameters are wavelength dependent. The sum of these three parameters must be one at any wavelength, as in the following equation:

α_{λ}+ρ_{λ}+τ_{λ}=1

In general, one of the key determinants in non-contact measurement of surface temperature is the emissivity of the surface. Increasing emissivity increases signal-to-noise ratio and reduces calibration errors. While there are methods available for increasing emissivity of free surfaces, there are very few results for increasing the emissivity of an interface between a metal and an infrared transparent window across which shear stresses need to be transmitted. Increasing emissivity has been particularly troublesome for such interfaces when the interface is loaded dynamically by stress wave loading that is heating the metal adjacent to the interface.

Common approaches for increasing surface emissivity involve applying a thin layer of highly emissive material to the surface. Representative materials applied include: black paint, powder, tape, and so forth. These materials have disadvantages of having low thermal conductivity, and being very soft. Low thermal conductivity tends to shield the outer surface of the applied layer from the temperature of the heated component whose temperature is to be measured. As a result, for transient temperature applications, the layer needs to be thin to increase thermal conductivity, but thick to provide high emissivity—posing difficulties for design selection. Softness of these layers greatly reduce their shearing resistance, precluding their use at interfaces where shear stresses must be transmitted. Another way to increase the emissivity is to roughen the surface, thereby largely preserving the thermal and mechanical properties of interfaces. Usual roughening approaches involve grinding or polishing, leading to unsatisfactory small increases in emissivity. For lapping, a precision film of slurry containing abrasive particle is applied between a hard lap plate and the sample. The loose and rolling abrasive particles within the slurry generate “micro-scratches” that give a uniform matte finish, which has much increased emissivity.

The present invention overcomes the difficulties of prior methods by using lapped metal plates backed by ZnSe windows in pressure-shear plate impact (PSPI) experiments. Lapping of the interfacial metal surface produces a uniformly smooth, reproducible, flat surface with a matte finish. The emissivity of the interface is increased substantially without changing its thermal and mechanical properties. For example, lapping of an aluminum interface increases the emissivity from less than 0.1 to greater than 0.5.

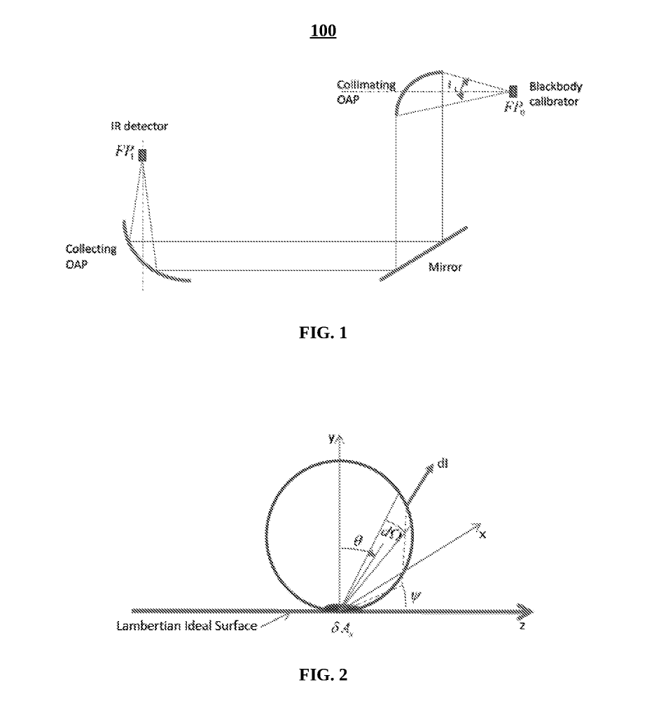

Referring now to FIG. 1, an exemplary infrared temperature measurement system 100 using 90 degree Off-Axis Parabolic (OAP) reflectors is illustrated. From Planck's Law, the spectral radiance

L^{e}_{Ω,λ}(λ,T)└W/(m³sr)┘

emitted from a blackbody is

$${L}_{Ω , λ}^{e} ( λ , T ) = \frac{2 {hc}^{2}}{{λ}^{5}} \frac{1}{exp ( \frac{hc}{λ {K}_{B} T} - 1 )} = \frac{{c}_{1}}{{λ}^{5}} \frac{1}{exp ( \frac{{c}_{2}}{λ T} - 1 )} \qquad ( 1.1 )$$

where h is Planck's constant, c is the speed of light and K_{B} is Boltzmann constant. Simplifying constants c₁, c₂, are c₁=1.19×10¹⁴ μm⁵, c₂=14404 μmK. The spectral radiance is the flux (not per unit area of the surface through which the radiation is passing, but per unit projected area of the surface from which the radiation is emitted) of radiation (a directional quantity), of wave length λ, emitted by the blackbody source, per unit solid angle per unit projected area of the source. This seemingly unorthodox use of the term “flux” is used in radiometry because of the convenience of relating directly the radiant power or energy flux (i.e., energy received, reflected, transmitted, or emitted per unit time; [W]) emitted by an incremental source area δA_{S} to the radiant power or energy flux incident on an incremental detector area δA_{d}.

The radiance

L^{e}_{Ω}(T)[W/(m²sr)]

for a source with multiple wavelengths is the flux per unit solid angle, per unit projected source area obtained by the integration of the spectral radiance over all wavelengths:

L^{e}_{Ω}(T)=∫₀^{λ}^{_{cutoff}}L^{e}_{Ω,λ}(λ,T)dλ. (1.2)

For a InSb detector, the cutoff wavelength is 5.4 μm; for a HgCdTe detector, the cutoff wavelength is 11.4 μm. The radiant intensity I(T) [Wsr⁻¹] is the radiant power per unit solid angle. It is defined by Lambert's cosine law: For an ideal diffusively reflecting or an ideally diffusively radiating surface the radiant intensity I is directly proportional to the cosine of the angle between the surface normal and the direction for which I is being detected.

In FIG. 2, an exemplary emission from a blackbody is shown. As illustrated, the incremental emitted radiant intensity is

dI^{e}(θ,T)=L^{e}_{Ω}(T)δA_{z} cos θdΩ (1.3)

for emission from a Lambertian ideal surface.

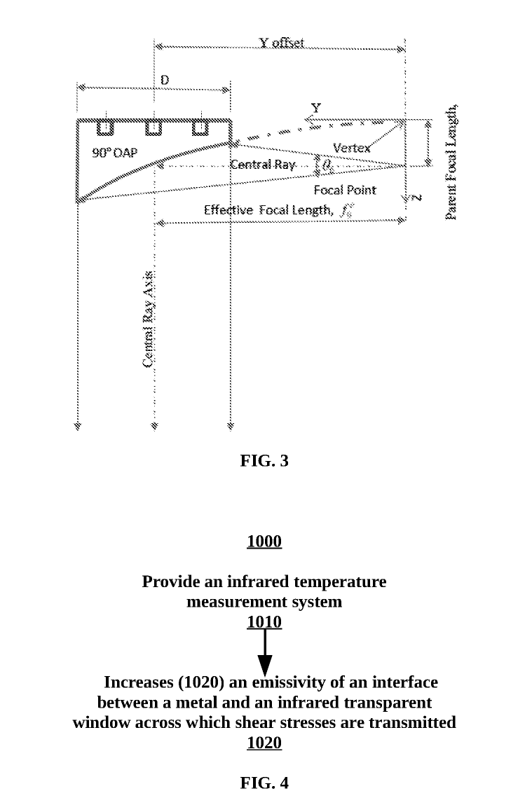

In FIG. 3, an exemplary layout of a collimating 90 degree OAP. Here, the total radiant power that is incident on the 90 degree collimating OAP is obtained by integrating (1.3) over the solid angle of the ray cone with vertex angle θ₀. The incremental solid angle is defined by

dΩ=sin(θ)dθd_{ψ}

where d_{Ψ} is an incremental angle about the axis of the cone. The angle θ sweeps over an interval, center on θ=0, with end points

−δθ₀⁻ and δθ₀⁺

such that

|δθ₀⁻|+|δθ₀⁺|=θ₀.

The radiant power emitted from the black body and incident on the OAP is

$${Φ}^{e} ( T ) = δ {A}_{s} {\int \int }_{{Ω}_{PR}^{*} ( θ , ψ )} {L}_{Ω}^{e} ( T ) cos ( θ ) sin ( θ ) d θ d ψ where {Ω}_{PR}^{e} \qquad ( 1.4 )$$

is the solid angle subtended by rays emanating from the focal point and reflecting from the surface of the OAP.

To prepare for the evaluation of the integral (1.4), the equation of the surface of the 90 degree collimating OAP is written as

$$z ( x , y ) - \frac{f}{{h}^{2}} \{ {x}^{2} + {y}^{2} \} = 0 \qquad ( 1.5 )$$

where h is the Y offset and f is the parent focal length—both shown in FIG. 3. We introduce spherical coordinates (r, θ, Ψ) (see FIG. 2 for identification of angles):

y=r cos θ

z=f+r sin θ cos ψ

x=r sin θ sin ψ. (1.6)

We substitute (1.6) into (1.5) to obtain the equation of the reflecting surface of the collimating 90 degree OAP in spherical coordinates:

$$\frac{f}{r} + sin θ - \frac{fr}{{h}^{2}} [ {sin}^{2} ψ {sin}^{2} θ + {cos}^{2} θ ] = 0. \qquad ( 1.7 )$$

The distance r(θ, Ψ) from the focal point to the collimating 90 degree OAP, along the ray in the direction of (θ, Ψ) is

$$r = r ( θ , ψ ) = \frac{\begin{matrix}{h}^{2} sin θ + {h}^{2} \\ {\{ {sin}^{2} θ + 4 ( {f}^{2} \text{/} {h}^{2} ) [ {sin}^{2} {ψsin}^{2} θ + {cos}^{2} θ ] \}}^{1 / 2}\end{matrix}}{2 f [ {sin}^{2} {ψsin}^{2} θ + {cos}^{2} θ ]} . \qquad ( 1.8 )$$

One possibility for the numerical evaluation of the integral (1.4) is to identify points in the domain

0≤θ≤π/2: 0≤ψ≤2π

whose distance from the focal point satisfies (1.8) and that lie within the boundary curve of the collimating 90 degree OAP. The boundary curve can be characterized as a curve on a circular cylinder with axis in the z-direction at distance h from the focal point and having diameter D. Whether points are inside or outside the boundary curve can be characterized by the sign of the area element subtended by a tangent vector to the boundary curve and a vector that connects the boundary point to a point that is clearly within the domain of interest (e.g., the point where the central ray intersects the OAP). To find the (θ, Ψ) domain of points that are on the curve of the boundary between the reflecting surface and the thin-walled tube that represents the outer cylinder of the collimating 90 degree OAP, we consider the two radii at which an extension of the ray (1.8) passes through this cylinder. The equation for the extended ray is

λr(θ,ψ) for λ≥1.

The equation for an infinitely long cylinder of radius D, parallel to the z-axis is

yₐ=h

(y−yₙ)²+x²=D²/4 (1.9)

or in spherical coordinates:

x=λr sin θ sin ψ

y=λr cos θ

(λr cos θ−h)²+(λr sin ψ)²=D²/4 (1.10)

From the roots λ are

$${λ}^{\pm } = \frac{h cos θ \pm {\{ ( {D}^{2} \text{/} 4 ) {cos}^{2} θ + ( {D}^{2} \text{/} 4 - {h}^{2} ) [ {sin}^{2} {θsin}^{2} ψ ] \}}^{1 / 2}}{r [ {cos}^{2} θ + {sin}^{2} {θsin}^{2} ψ ]} . \qquad ( 1.11 )$$

As long as the radicand is positive, and one root is positive, one can set λ=1 to find a relation between θ and Ψ on the boundary of the domain over which (1.4) needs to be integrated. Then, whether or not a ray hits the OAP can be determined by the sign of the projection

[(r(θ,ψ)−r₀(θ,ψ))×t₀(θ,ψ)]·j (1.12)

where subscripts denote evaluation for points on the boundary described by (1.11) for λ=1; t₀ is a tangent vector along the boundary curve.

Once the emitted power is calculated from (1.4), the same approach can be used to calculate the radiant power incident on the IR detector from

$${Φ}^{d} ( T ) = δ {A}_{d} {\int \int }_{{Ω}_{PR}^{*} ( θ , ψ )} {L}_{Ω}^{e} ( T ) cos ( θ ) sin ( θ ) d θ d ψ \qquad ( 1.13 )$$

where the area δA_{d} is the area onto which the emitted power from the area δAₛ is incident on the focal plane of the collecting OAP. From the conservation of radiant power along the IR detection system,

Φ^{e}=Φ^{d}. (1.14)

If the full radiant power

Φ^{d}(T)

is detected by the window of the IR detector, then the recorded voltage V(T) is,

V(T)=R(A_{d}L^{d}_{Ω}(T))=RL^{e}_{Ω}(T)δA_{z}. (1.15)

where A_{d} is the area of the detector window and R[V/W] is the sensitivity of the IR detector.

Infrared measuring devices acquire infrared radiation emitted by an object and transform it into an electronic signal. Digitization begins with a sensor or detector that transforms infrared radiation into an electronic signal. The detector provides a voltage proportional to the received radiation. Equation (1.15) can be used in designing and calibrating temperature measurement systems based on monitoring infrared radiation.

The method described above, when used with metal foils having high thermal conductivity (e.g., copper and aluminum), enables accurate temperature measurements even in dynamic environments.

Higher emissivity, and its associated advantages, can be achieved with thinner foils than for current technology using, for example, polymeric tapes.

A “Post-It” like design enables easy removal of lapped foil once temperature is measured

Removed lapped foils can possibly be re-usable.

The method described herein may include proprietary or non-proprietary software for matching lapping parameters and detector parameters for a wide range of applications.

As shown in FIG. 4 a process 1000 includes providing (1010) an infrared temperature measurement system.

Process 1000 increases (1020) an emissivity of an interface between a metal and an infrared transparent window across which shear stresses are transmitted.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method comprising:
providing an infrared temperature measurement system; and
increasing an emissivity of an interface between a metal and an infrared transparent window across which shear stresses are transmitted.

2. The method of claim 1 wherein the infrared temperature measurement system comprises at least a source of infrared radiation and an IR detector for calculating an emitted power from the interface when exposed to the source of infrared radiation.

3. The method of claim 1 wherein increasing the emissivity comprises using lapped metal surfaces backed by ZnSe windows.

4. The method of claim 1 wherein increasing the emissivity enables temperature measurement at the interface.

5. The method of claim 1 wherein increasing the emissivity enables temperature measurement at a free surface of a lapped metal.

6. The method of claim 1 wherein increasing the emissivity enables temperature measurement at a foil bonded thermally to a shiny metal surface.

7. The method of claim 1 wherein increasing the emissivity enables temperature measurement at a foil bonded thermally and mechanically to a metal surface using a permanent mechanical bond.

8. The method of claim 6 further comprising removing the foil once temperature is measured.

9. The method of claim 8 wherein the foil is re-usable.

10. A method comprising:
providing an infrared temperature measurement system, the infrared temperature measurement system comprising at least a source of infrared radiation and an IR detector for calculating an emitted power from the interface when exposed to the source of infrared radiation; and
increasing an emissivity of an interface between a metal and an infrared transparent window across which shear stresses are transmitted.

11. The method of claim 10 wherein increasing the emissivity comprises using lapped metal surfaces backed by ZnSe windows.

12. A method comprising:
providing an infrared temperature measurement system, the infrared temperature measurement system comprising at least a source of infrared radiation and an IR detector for calculating an emitted power from the interface when exposed to the source of infrared radiation; and
increasing an emissivity of an interface between a metal and an infrared transparent window across which shear stresses are transmitted, wherein increasing the emissivity comprises using lapped metal surfaces backed by ZnSe windows.
